(19) United States
(12) Patent Application Publication
(10) Pub. No.: US 2024/0159638 A1
(43) Pub. Date: May 16, 2024

(54) Apparatus, home appliance and method for particle sizing

(71) Applicant: emz-Hanauer GmbH & Co. KGaA, Nabburg (DE)

(72) Inventor: Lukas Schade, Nabburg (DE)

(21) Appl. No.: 18/373,493

(22) Filed: Sep. 27, 2023

(30) Foreign Application Priority Data
Nov. 14, 2022 (DE) 102022130055.2

(51) Int. Cl. G01N 15/02; A47L 15/00; A47L 15/42; D06F 33/37; D06F 34/22; D06F 34/26; D06F 58/22; D06F 58/36

(52) U.S. Cl. CPC G01N 15/0205; A47L 15/0021; A47L 15/0055; A47L 15/4297; D06F 33/37; D06F 34/22; D06F 34/26; D06F 58/22; D06F 58/36; A47L 2401/10; A47L 2501/01; A47L 2501/07; A47L 2501/30; D06F 2103/28

(57) ABSTRACT

The invention relates to a device for particle sizing of particles distributed in a fluid within a household appliance, comprising at least one first emission means emitting a first electromagnetic radiation along a first optical axis into the fluid present in a test volume, at least one first measuring means detecting at least one characteristic of a second electromagnetic radiation emerging from the fluid an evaluation means provided and adapted to evaluate the characteristics of the second electromagnetic radiation, whereby particle sizes can be detected using reference characteristics, wherein the emitted first electromagnetic radiation is quasi-monochromatic or is a sequence of predetermined wavelengths within a predetermined time interval, the first measuring means being arranged off the first optical axis

### CROSS-REFERENCE TO RELATED APPLICATIONS

This patent application claims the benefit of and priority to German Patent Application No. 10202213 055.2, filed on Nov. 14, 2022, which is herein incorporated by reference in its entirety.

### FIELD

The invention relates to a device for particle sizing of particles distributed in a fluid within a household appliance. Furthermore, the invention relates to a household appliance comprising such a device and an associated procedure for particle sizing of particles distributed in a fluid within a household appliance.

### BACKGROUND

Turbidity sensors within household appliances are known from the prior art, which can detect turbidity and thus the presence of foreign matter, such as contaminants or cleaning agents, in a fluid within the household appliance via transmission measurements. Such turbidity sensors have the advantage of simple measurement geometry and low cost. However, no further characterization of the impurities present in the fluid is provided.

Further characterization of the impurities is desirable in many respects. In a dishwasher or washing machine, the type and degree of contamination can be determined so that, as a result, action can be taken to best remove the contamination from the items being cleaned. However, it is equally desirable to detect detergents in the water in order to determine whether the objects to be cleaned are free of them at the end of the cleaning process.

### SUMMARY

Accordingly, further measures can only be insufficiently adapted and carried out by the turbidity sensors known from the prior art. On the other hand, in order to be able to make further statements about the foreign substances, more complex and more expensive sensors have had to be used up to now.

Against this background, the object of the present invention is to provide a device, a household appliance and a procedure which are capable of overcoming the disadvantages mentioned at the beginning.

The object is solved by the objects of claims 1 and 11 and by the procedure according to claim 15. Advantageous embodiments are to be taken from the sub-claims.

The core idea of the invention is a device for particle sizing of particles distributed in a fluid within a household appliance, comprising at least a first emission means emitting a first electromagnetic radiation along a first optical axis into the fluid present in a test volume, at least a first measuring means at least one first measuring means detecting at least one characteristic of a second electromagnetic radiation emerging from the fluid, and an evaluation means provided and adapted to evaluate the characteristic of the second electromagnetic radiation, whereby particle sizes can be detected using reference characteristics, the first measuring means being arranged off the first optical axis.

The term “substantially” as used herein is intended to be construed to include claiming minor tolerance variations with respect to a feature.

Such household appliances may be, for example, a refrigerator or a clothes dryer, as well as water-using household appliances such as, for example, a dishwasher or a washing machine or the like. The household appliances have at least in common that a fluid is conducted within the household appliance, for example in a respective container means, in inlets and outlets or in bypasses. Here, the container means of a washing machine or dishwasher would correspond to a caustic container in which the items to be washed are located. Furthermore, the container means could be a drying chamber of a dryer or a cooling chamber of a refrigerator, in which the objects to be cooled are located.

The fluid according to the invention is liquid or gaseous. In particular, the main component of the liquid fluid is water, primarily tap water. The gaseous fluid is essentially air. In addition to the main constituents water or air, the fluid may also contain other substances or groups of substances. These substances are present, for example, dissolved or mixed in the fluid, as well as suspended or emulsified particles or as aerosol particles in the fluid.

According to a preferred embodiment, it is advantageous that the emitted first electromagnetic radiation emits a predetermined wavelength range. Preferably, the wavelength range comprises a mean wavelength km and a finite linewidth Δλ, where Δλ is small compared to the mean wavelength (Δλ<λm). Such emitted radiation may be referred to as near-monochromatic or quasi-monochromatic. Preferably, the first electromagnetic radiation is quasi-monochromatic or near-monochromatic. Monochromatic radiation, i.e., with an exactly sharp wavelength, is not possible simply because of the frequency-time uncertainty relationship. Therefore, any real radiation is subject to a finite linewidth Δλ. For a quasi-monochromatic or near-monochromatic radiation, Δk is small (Δλ<λm), preferably very small (Δλ<<λm), compared to the average wavelength. It is also conceivable that the emitted radiation is polychromatic. Such radiation comprises several color components. This would apply, for example, to white light. An exemplary radiation source would be a white light LED.

Preferably, emitted first electromagnetic radiation (11) is a sequence of predetermined wavelengths within a predetermined time interval. Accordingly, the first radiation can also be a temporal sequence of wavelengths. Preferably, several quasi-monochromatic radiations are emitted in a temporal sequence. Thereby, the mean wavelength (λm) is varied from a first wavelength (λm1) to a second wavelength (λm2). Thus, a wavelength range ([λm1, λm2]) is emitted with a predetermined variation speed within a predetermined time interval. Preferably, the mean wavelength is thereby increased or decreased with increasing time.

According to a preferred embodiment, the wavelength or the mean wavelength of the emitted first electromagnetic radiation is in a range from 200 nm to 10000 nm, more preferably in a range between 380 nm and 1 μm (visible to IR range), more preferably in a range between 380 nm to 780 nm (visible range). Furthermore, the aforementioned wavelength range ([λm1, λm2]) may correspond to the aforementioned preferred ranges or be a sub-interval within the aforementioned ranges. Advantageously, the wavelength of the emitted first electromagnetic radiation is adjustable by the first emission means. Preferably, the first emission means comprises at least one emission unit with an adjustable wavelength selected from a group comprising an LED, for example an RGB or RGBW LED, a laser or the like. The emission unit is not intended to be limited to said units, what is crucial is the emission of an electromagnetic radiation with substantially an adjustable wavelength. Preferably, the emission unit or emission means may emit different wavelengths in a time-shifted or sequential manner.

Preferably, the first emission means comprises two, three or more than three further emission units. Preferably, the emission means can be controlled in such a way that they emit partial intervals of the wavelength range ([λm1, λm2]) one after the other. The wavelength range ([λm1, λm2]) can thus be tuned in a range extending from the infra-red range to the visible range and preferably up to the UV range. Of course, the reverse order can also be implemented. The emission means are preferably controlled by means of a corresponding control means so that the average wavelength is varied in the specified time interval. Preferably, the average wavelength is increased or decreased with increasing time.

According to the invention, an optical axis is understood to be the axis or path along which the electromagnetic radiation passes through the fluid or interacts with it. In the context of the invention, a very simple measurement geometry, a so-called “off-axis” arrangement, i.e. away from the first optical axis, is used to ensure further characterization of substances present in a fluid within a household appliance. Thus, according to the invention, radiation emerging from the fluid is detected and evaluated, from which a particle size can be inferred using reference characteristics. The arrangement according to the invention is simple and inexpensive and is based on an angle-dependent measurement.

According to a preferred embodiment, the first measuring means is arranged at an angle in a range of [0°;180°] to the first optical axis. Preferably, the first measuring means is arranged at an angle of 15°, 30°, 45°, 60°, 90°, 120° or 150° to the first optical axis. Preferably, therefore, the first measuring means detects at least a portion of the second electromagnetic radiation at a certain angle to the first optical axis. The first measuring means is provided and configured to detect a second electromagnetic radiation that has emerged from the fluid. Preferably, the first measuring means can detect those radiation characteristics which are suitable for the detection of groups of substances.

Preferably, the second electromagnetic radiation is a scattered radiation, in particular caused by Mie scattering and/or Rayleigh scattering. Preferably, the second electromagnetic radiation is caused by scattering of the first electromagnetic radiation by the particles distributed in the fluid. The second electromagnetic radiation off the optical axis corresponds to a lateral scattering radiation which arises due to the scattering of the first electromagnetic radiation with particles in the fluid. The lateral scattered radiation depends on various factors, in particular on the wavelength of the emitted, first electromagnetic radiation as well as on the particle size of the particles and their concentration in the fluid as well as on the distance between the measuring means and the scattering volume or the test volume with the fluid. The scattering radiation behavior depends in particular on the particle size of the group of substances to be detected in relation to a respective wavelength. We speak of Mie scattering when the diameter of the particle corresponds approximately to the wavelength. In the case of Rayleigh scattering, the diameter of the particle is small compared to the wavelength. Thus, the particle size can be advantageously inferred from the detected scattering behavior.

According to a preferred embodiment, the first measuring means is provided and designed to detect an intensity of the second electromagnetic radiation. Preferably, the first measuring means comprises precisely one sensor unit which detects the intensity of the second electromagnetic radiation as a function of the angle. Further preferably, the sensor unit is selected from a group comprising a photodiode, a phototransistor and a bolometer. The sensor units mentioned are particularly inexpensive and simple in design. In contrast to a spectroscopic evaluation of the scattered radiation, preferably only the integrated spectrum is detected by the first measuring means, for example in the form of a photodiode, and then fed to the further evaluation. Furthermore, in comparison to a spectroscopic evaluation, a grating or a prism can be completely dispensed with.

According to a preferred embodiment, the device comprises a second emission means which emits a third electromagnetic radiation along a second optical axis into the fluid present in the test volume. Preferably, the emitted third electromagnetic radiation is quasi-monochromatic or a sequence of predetermined wavelengths within a predetermined time interval. All comments made regarding the first electromagnetic radiation may apply mutatis mutandis to the third electromagnetic radiation, and vice versa. Preferably, the wavelength of the first electromagnetic radiation and the wavelength of the third electromagnetic radiation are the same or different. Preferably, the second emission means comprises at least one emission unit with an adjustable wavelength selected from a group comprising an LED, in particular an RGB or RGBW LED, and a laser. All remarks made about the first emission means can mutatis mutandis also apply to the second emission means and vice versa.

According to a preferred embodiment, the first optical axis and the second optical axis are arranged at an angle in a range of [0°;180°] to each other. Preferably, the first optical axis and the second optical axis intersect within the test volume in the fluid. The intersection of the first optical axis and the second optical axis is therefore preferably within the test volume or within the fluid. Further preferably, the first measuring means is arranged away from the first optical axis and the second optical axis. In this way, the first measuring means measures or detects the second electromagnetic radiation, whereby the second electromagnetic radiation is a scattered radiation consisting of a scattered radiation of the first and third electromagnetic radiations. Thus, further information for a more precise determination of the particle size is obtained with only one measuring device.

By using the second emission means, it is possible to detect the scattered radiation in a more angle-dependent manner, which means that the particle size can be determined more accurately and reliably.

According to a preferred embodiment, the device comprises a second measuring means that detects the characteristics of the second electromagnetic radiation emitted from the fluid. Preferably, the second measuring means is arranged away from the first optical axis and the second optical axis. Further preferably, the first measuring means and the second measuring means are rotationally offset about the first optical axis and the second optical axis. Further preferably, further measuring means are arranged in each case off the first optical axis and the second optical axis, which in each case detect the characteristic of the second electromagnetic radiation emerging from the fluid, the further measuring means s being arranged in each case rotationally symmetrically offset about the first optical axis and the second optical axis. A rotationally symmetrical offset of the measuring means s means that the measuring means s are each arranged at a different angle to the first and the second optical axis. In this way, the measuring devices can detect or record the characteristics of the second electromagnetic radiation at a different angle in each case. For example, three measuring devices can detect the characteristic of the second electromagnetic radiation at an angle of 30°, 90° and 120°. By detecting the characteristic of the second electromagnetic radiation from different angles, information about the geometric distribution of the lateral scattered radiation can advantageously also be obtained. Knowledge about the geometric distribution of the lateral scattered radiation is advantageous in that more precise conclusions about the particle size of the particles can be drawn therefrom.

The explanations and described features for the first measuring means also apply mutatis mutandis to the second and the further measuring means, which are arranged away from the optical axes.

According to a preferred embodiment, the device comprises a third measuring means which detects at least one characteristic of a fourth electromagnetic radiation emerging from the fluid. The third measuring means is provided and configured to detect a fourth electromagnetic radiation emanating from the test volume. Preferably, the third measuring means is arranged along the first optical axis or the second optical axis. Preferably, the third measuring means is arranged in the optical path emanating from the emission device downstream of the test volume. Preferably, the fourth electromagnetic radiation is substantially the same as the first electromagnetic radiation when arranged along the first optical axis or the third electromagnetic radiation when arranged along the second optical axis. Preferably, the first or third electromagnetic radiation is emitted along the first or second optical axis, respectively, in a forward direction or in a propagation direction, the electromagnetic radiation being considered as a light beam. If the propagation direction of the light beam changes, for example due to deflection or reflection, the forward direction also changes. Preferably, the fourth electromagnetic radiation is detected in the forward direction. However, the third measuring means is only optional. Conceivable is an embodiment in which no measurement in transmission, i.e. no measurement of the fourth electromagnetic radiation takes place. Thus, exclusively a measurement with the “off-axis” arrangement, i.e. away from the first optical axis, would be performed.

According to a preferred embodiment, the second measuring means and/or the third measuring means is provided and designed to detect an intensity of the second electromagnetic radiation. Advantageously, the third measuring means is also provided and designed to detect an intensity of the third electromagnetic radiation. Preferably, the second measuring means and/or the third measuring means comprise exactly one sensor unit which detects the intensity of the respective electromagnetic radiation. Further preferably, the sensor unit is selected from a group comprising a photodiode, a phototransistor and a bolometer. The sensor units mentioned are particularly cost-efficient and simple. Thus, advantageously, no spectroscopic evaluation of the respective radiation is carried out by the first measuring means, preferably also by the second and third measuring means s. Only the intensity of the scattered and, if applicable, the transmitted radiation, i.e. the absorption in the fluid, is measured. Compared to a spectroscopic evaluation, a grating or a prism can be completely omitted.

According to one embodiment, the first emission means emits the first electromagnetic radiation and the second emission means emits the third electromagnetic radiation simultaneously. Alternatively, the emission means emit the first electromagnetic radiation with a time delay or one after the other. According to a preferred embodiment, the fourth electromagnetic radiation and the reference characteristics include spectral information about the substance group-specific ab sorption behavior, scattered radiation behavior or luminescence behavior or any combination thereof.

The evaluation means is provided and designed to evaluate at least one characteristic of the second electromagnetic radiation. Preferably, the evaluation means is provided and designed to additionally evaluate the characteristic of the fourth electromagnetic radiation. The evaluation is preferably performed with the aid of artificial intelligence and/or machine learning. The evaluation means is at least signal-technically connected with the measuring means or the measuring means s, so that at least the detected characteristic of the respective electromagnetic radiation can be sent from the measuring means to the evaluation means. Preferably, the characteristics are angle-dependent spectral measured values of the second electromagnetic radiation or spectral measured values of the fourth electromagnetic radiation. Using reference characteristics, the respective particle sizes can thus be detected.

According to the invention, a reference characteristic refers to a characteristic of a reference that has been recorded or detected or determined in advance. The reference can be a pure fluid without particles or substances distributed therein in order to obtain the characteristics of the pure fluid. Furthermore, the reference can be a sample with a fluid with distributed particles or substances whose particle size and/or substance groups are known. By recording or detecting or determining the characteristics of these known references and comparing them with the measurement result of the unknown sample, it is possible to draw conclusions about the particle sizes and/or substance groups. The reference characteristic can be a correlation between irradiated wavelength and detected intensity or the like. Preferably, a reference characteristic is created in advance for each particle size to be detected and/or from a combination of different particle sizes at different angles to the optical axis, depending on the arrangement of the measuring means to the optical axis, preferably at different temperatures and/or concentrations of the particles in the fluid. Preferably, a reference characteristic exists for each particle size and/or for combinations of different particle sizes at different angles corresponding to the measuring means arrangements, so that a typical reference characteristic can be assigned to each particle size, and vice versa. Preferably, reference characteristics are available which essentially contain information about the scattering radiation behavior of a particle size to be detected.

When varying the first electromagnetic radiation within a predetermined time interval, a wavelength range ([λm1, λm2]) with a predetermined variation rate can be obtained for the different wavelengths in the wavelength range ([λm1, λm2]) preferably a wavelength-dependent reflection characteristic and preferably a wavelength-dependent absorption characteristic. The substance groups to be detected cause typical spectral measurement values, so-called fingerprints, in the characteristics of the reflected or transmitted electromagnetic radiation in the fluid. By using reference characteristics, the respective groups of substances can be recognized. Preferably, in addition to the respective group of a substance, a concentration, a density or a quantity of the substance in the fluid is also detected. Preferably, a reference is created in advance for each group of substances to be detected and/or from a combination of different groups of substances, preferably at different temperatures and/or concentrations of the groups of substances in the fluid. Preferably, a reference characteristic exists for each substance group and/or for combinations of different substance groups, which contains substance group-specific information. Substance group specific information are preferably changes of the characteristic of the detected electromagnetic radiation compared to this characteristic of the first electromagnetic radiation, especially absorptions and emissions of wavelengths, etc. Preferably, reference characteristics are available which essentially contain information about the absorption behavior of a group of substances to be detected, as well as reference spectra which essentially contain information about the scattered radiation behavior of a group of substances to be detected. The same applies to the luminescence behavior.

The evaluation of the characteristics of the second and/or fourth electromagnetic radiation takes place using the reference characteristics or reference spectra. Preferably, at least in a partial step of the evaluation, the characteristic of the respective electromagnetic radiation, a modified or converted characteristic of the respective electromagnetic radiation or a characteristic of the respective electromagnetic radiation modified by means of a procedure is compared with the reference characteristic, whereby preferably by this comparison the groups of substances to be recognized can be recognized.

Preferably, all essential substance groups of dirt, cleaning agents and biological degradation products in the fluid can be detected. Thus, substance group specific measures can be taken to improve a cleaning result or freshness. The recognition of the substance groups of the dirt is advantageous in that the cleaning of the objects to be cleaned can be tailored to the recognized substance groups and thus optimized. As a result, power consumption, water consumption and consumption of cleaning agents can be significantly reduced and the environment can be protected. The detection of the substance groups of the cleaning agent is advantageous in that the amount of fresh water for rinsing the objects to be cleaned can be reduced, since it can be reliably detected when the objects to be cleaned are free of cleaning agents. The detection of biological degradation products is advantageous in that an incipient biological degradation process can be detected even before a foodstuff spoils and thus has to be disposed of. The entirety of the substance groups to be detected exhibit fingerprints over the entire wavelength range of visible light and infrared radiation. With a more limited emitted wavelength range, not all of the substance groups to be detected can be identified, so that valuable resources cannot be optimally conserved. Preferably, the groups of substances are grouped according to their chemical compound and detected by the device. Detectable substance groups of dirt include organic molecules such as fats, proteins, carbohydrates and their degradation products. Inorganic dirt includes compounds such as inorganic soot, lime, minerals and metal compounds, as well as cleaning agents, at least comprising anionic and non-anionic surfactants, water softeners, bleaches, enzymes, dirt carriers, salts, curd soaps and silicones. Advantageously, groups of substances can be better identified from the combination of evaluations of the characteristics of the second and fourth electromagnetic radiations.

Each substance group in the fluid exhibits its own specific behavior due to the interaction with the first and/or third electromagnetic radiation. In the case of absorption, at least some of the particles or the molecules absorb one or more wavelengths or wavelength ranges at least partially, so that in the case of a tuning of the wavelengths within the wavelength range, ([λm1, λm2]) certain wavelengths are at least partially filtered out of the first and/or third electromagnetic radiation and are thus at least less present in the fourth electromagnetic radiation. Similarly, during reflection, at least some of the particles or the molecules reflect one or more wavelengths or wavelength ranges at least partially.

According to a preferred embodiment, the first and/or the third electromagnetic radiation can be introduced into the test volume via a first light guide from the respective emission means or emission unit. Preferably, the fourth electromagnetic radiation can be guided out of the test volume via a second light guide. In particular, the light guides conduct the electromagnetic radiation in the wavelength range of visible light, infrared radiation and preferably UV radiation, in particular without loss, and are accordingly transparent for wavelengths in this wavelength range. In this context, the light guides can be formed as fibers, tubes or rods, or from a combination thereof.

Preferably, the first light guide is arranged within a substantially transparent housing. Furthermore, it is advantageous that the first measuring means and/or the second measuring means is arranged in a substantially transparent housing. Furthermore, it is preferred that the second light guide is arranged within a substantially transparent housing. By providing the transparent housing, the light guides as well as the measuring means (s) are sufficiently protected from contamination and further influences by the fluid. Furthermore, since the housings are essentially trans-parent for the wavelengths used, they influence the respective radiation only insignificantly. The term “essentially transparent” should be interpreted in such a way that only negligible losses of the radiation passing through the housing occur. Preferably, said housings are waterproof.

According to a preferred embodiment, the first light guide and the second light guide are rod-like along a longitudinal direction at least in the test volume and are arranged parallel to each other. Rod-like means that the light guides are solid or rigid and are significantly longer in the longitudinal direction than in a transverse direction. The first electromagnetic radiation preferably propagates along the longitudinal direction in the first light guide. Preferably, the first and/or the third electromagnetic radiation are totally reflectable into the fluid in the test volume at a first distal end of the first light guide. Preferably, the total reflection is provided by the first and third electromagnetic radiations being totally reflected at the surface from an optically denser medium to an optically thinner medium starting at a physically determined critical angle, wherein the light guides consist of the optically dense medium and the fluid consists of the optically thin medium.

Preferably, the first and/or the third electromagnetic radiation pass into the second electromagnetic radiation and preferably the fourth electromagnetic radiation by the interaction with the fluid along a test section in the test volume. The interaction preferably takes place by absorption, reflection, scattering and luminescence of the first and/or the third electromagnetic radiation with the fluid. Preferably, there is an interaction of the first and/or the third electromagnetic radiation with particles or particles or molecules of the groups of substances to be detected. Preferably, the second electromagnetic radiation is substantially equal to a sum of the first and third electromagnetic radiations, but different due to the interaction of the first and third electromagnetic radiations with the particles or particles of the groups of substances in the fluid.

Preferably, the fourth electromagnetic radiation is totally reflectable at a second distal end of the second light guide in a direction opposite to the longitudinal direction. Preferably, total reflection is provided by fully reflecting the fourth electromagnetic radiation at the surface from the optically denser medium of the second light guide to the optically thinner medium of the fluid. More details will be explained with reference to the figures. Alternatively, the surface may be a mirror surface.

The object is further solved by a household appliance, comprising a device according to the invention and at least one control means which is connected to the evaluation means in terms of signals, the control means controlling further means of the household appliance as a function of the determined particle sizes and/or substance groups.

The household appliance is, for example, a washing machine, a dishwasher, a dryer, a refrigerator or any other such household appliance.

Preferably, the control means is a separate device within the household appliance. Further preferably, the control means is integrated into a higher-level control means.

Preferably, there is a data link between the control means and the evaluation means, the evaluation means sending data on the respective particular particle size and/or detected substance group and the respective detected concentration of the particular particle size and/or detected substance group to the control means. Preferably, for each particular particle size and/or detected substance group, preferably for each combination of detected substance groups, a measure is preprogrammed which the control means is to undertake. According to the invention, these measures correspond to the control of further means of the household appliance.

Preferably, the reference characteristics can be retrieved by the evaluation means from a memory unit. Alternatively or cumulatively, the reference characteristics can be retrieved from a server by means of a wireless connection, the server preferably not being part of the household appliance. Accordingly, the household appliance may include an interface for communicating with the server.

According to a preferred embodiment, the main component of the fluid is air. Preferably, such a household appliance is a dryer or a refrigerator.

Preferably, the control means controls an air filter device depending on the determined particle size and/or the detected groups of substances. For example, biological degradation products produced during ripening, wilting or decomposition are present in the air inside the refrigerator compartment of a refrigerator. The particle sizes and/or substance groups are determined or detected by the evaluation means and sent to the control means. The control means can then activate the air filter device. This has the advantage that, depending on the determined particle size and/or detected substance groups, these can be filtered out of the air and thus not transferred to other perishable foodstuffs.

Alternatively and cumulatively, the control means can control an air treatment device. For example, the air can thus be processed in a dryer.

Alternatively and cumulatively, the control means may control a communication means that may communicate information to a user. For example, the communication means may be a display on the household appliance, for example the refrigerator, or it may be a device that sends a message to a user's device. Now, for example, if a process of wilting starts, the user can be alerted via the communication means.

According to an alternatively preferred embodiment, the main component of the fluid is water. Preferably, such a household appliance is a washing machine or a dishwasher. In addition to the main component water, the fluid contains in particular cleaning agents and impurities or dirt.

Preferably, depending on the determined particle size and/or detected groups of substances, the control means can control a metering means for cleaning agent, which can supply a type, a composition and/or an amount of the cleaning agent to the water. In particular, the cleaning agent is adapted in such a way that the detected impurities can be removed in the best possible way. In particular, the cleaning agent can be composed of several components, each individual component being able to eliminate a specific group of substances, for example fats, proteins, carbohydrates or inorganic contaminants. If, for example, fats are predominantly present in the fluid, the component that can remove fats from the objects to be cleaned is also predominantly added to the cleaning agent.

Alternatively and cumulatively, the control means can control a feeder means that can add a quantity of water to the cleaning process at a specific time or period. If, for example, the evaluation means detects that the concentration of groups of contaminants is low, a quantity of water can be advantageously saved. Further water savings potential is offered at the end of the washing or rinsing process. The aim here is to remove the residual cleaning agents from the items to be cleaned, and the items are rinsed with fresh water. This amount of fresh water is overkill in the prior art, since without detecting the cleaning agents, it must be ensured that the objects are essentially free of cleaning agents. Accordingly, the advantage of this preferred embodiment is that the supply of fresh water can be limited once it is detected that the fluid is substantially free of cleaning agents.

Alternatively and cumulatively, the control means can control an adjusting means that can adjust a cleaning program selected from a plurality of cleaning programs. Preferably, the cleaning programs differ in cleaning duration, cleaning temperature, and cleaning cycles such as pre-rinse cycle, main rinse cycle, post-rinse cycle, and so forth. By selecting the cleaning program depending on the specific particle size and/or detected groups of substances, valuable resources such as energy and time can be advantageously saved in addition to water and cleaning agent. According to a preferred embodiment, the test volume of the device is located in a machine sump of the washing machine or dishwasher. Alternatively, the test volume is located in a fluidically separable bypass.

The object is further solved by a procedure of claim 14, which procedure may be provided with all features already described above in the context of the device and the household appliance, individually or in combination with each other, and vice versa.

According to the invention, a procedure for particle sizing particles distributed in a fluid within a household appliance, comprising the method steps:
a. emitting a first electromagnetic radiation along a first optical axis into the fluid present in a test volume emitted by means of a first emission means;
b. detecting at least one characteristic of a second electromagnetic radiation emitted from the fluid by means of a first measuring means;
c. evaluating the characteristic of the second electromagnetic radiation by means of an evaluation means; and
d. determining the particle sizes using reference characteristics by means of the evaluation means;
wherein the first measuring means is arranged off the first optical axis (X).

Preferably, the emitted first electromagnetic radiation is nearly monochromatic or is a sequence of predetermined wavelengths within a predetermined time interval.

Preferably, the characteristic of the second electromagnetic radiation exhibits a spectral parameter of the respective wavelength. Preferably, the spectral parameter corresponds to an intensity or a radiance, although any other spectral parameter may be considered that at least indicates how much is detected at the corresponding angle of the measuring means.

Preferably, the above procedure may also be applied mutatis mutandis to the evaluation of the characteristics of the fourth electromagnetic radiation and shall be disclosed therefor. Preferably, the particle sizes and/or substance groups are detected according to method step d. by the evaluation means comparing the characteristic with a plurality of reference characteristics.

Furthermore, in order to solve the problem, a procedure is claimed for adapting a cleaning process of a water-carrying household appliance as a function of certain particle sizes and/or detected substance groups in the water of the household appliance, comprising at least one of the following procedure steps:
e. controlling the metering means for cleaning agent by means of the control means, which can supply a type, a composition and/or an amount of the cleaning agent to the water;
f. controlling the feeder means by means of the control means, which can supply an amount of water; and
g. controlling the adjusting means by means of the control means, which can adjust a cleaning program selected from a plurality of cleaning programs.

The procedure may be provided with all the features already described above in the context of the device, the household appliance and the procedure for particle sizing, individually or in combination with each other, and vice versa.

### BRIEF DESCRIPTION OF THE DRAWINGS

Further advantages, objectives and features of the present invention will be explained with reference to the following descriptions of the accompanying figures. Similar components may have the same reference signs in the various embodiments.

The figures show:

FIG. 1 a principle sketch of a device according to one embodiment;

FIG. 2 a principle sketch of a device according to one embodiment;

FIG. 3 a principle sketch of a device according to one embodiment;

FIG. 4 a principle sketch of a device according to one embodiment;

FIG. 5 a principle sketch of a device according to one embodiment;

FIG. 6 a representation of a device according to one embodiment with a component;

FIG. 7 a representation of a household appliance according to one embodiment;

FIG. 8 a flow diagram of a procedure according to one embodiment.

In the figures, identical components or elements are to be understood with the corresponding reference lines in each case. For the sake of clarity, in some figures components may not be designated with a reference sign, but have been designated elsewhere.

### DETAILED DESCRIPTION

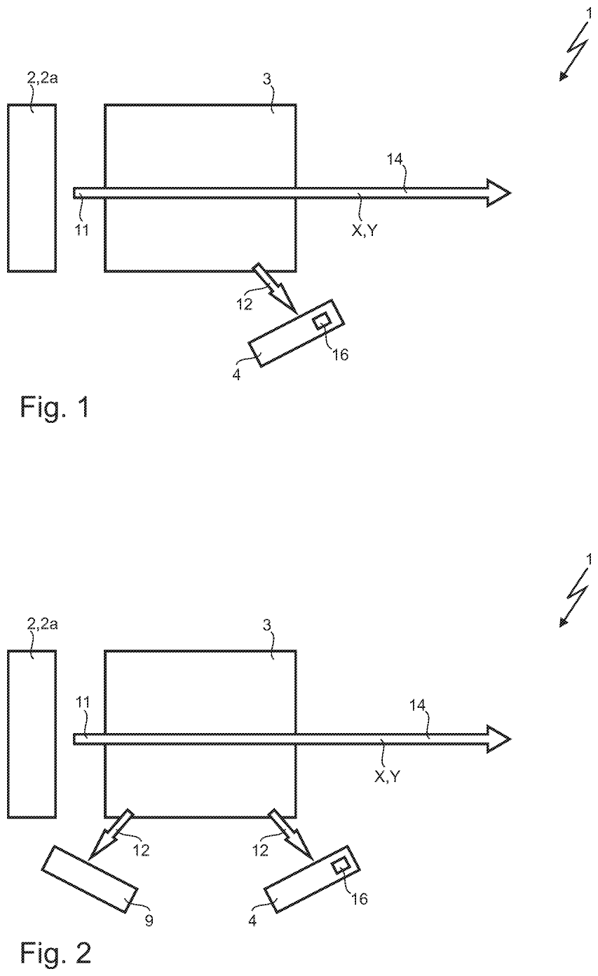

FIG. 1 shows a device 1 according to one embodiment as a principle sketch. A first emission means 2 preferably having an emission unit 2a with an adjustable wavelength emits a first electromagnetic radiation 11, which according to a preferred embodiment is nearly monochromatic or is a sequence of predetermined wavelengths within a predetermined time interval. The first electromagnetic radiation 11 propagates along a first optical axis X in a forward direction Y into a test volume 3. A fluid is present in the test volume 3, particles being distributed in the fluid whose particle size can be determined by the device 1. Away from the first optical axis X, a second electromagnetic radiation 12 is detectable by at least one first measuring means 4, wherein the first measuring means 4 is arranged at an angle in a range of [0°;180° ] to the first optical axis X. The second electromagnetic radiation 12 is generated due to a lateral scattering of the first electromagnetic radiation 11 with the particles in the fluid. The first measuring means 4 can thus advantageously detect a characteristic of the second electromagnetic radiation 12, as well as information on the geometry of the scattered radiation, which is characteristic of the particle size.

The first measuring means 4 is provided and designed to detect an intensity of the second electromagnetic radiation 12. The first measuring means 4 comprises exactly one sensor unit 16, which detects the intensity of the second electromagnetic radiation 12 in an angle-dependent manner.

The wavelength of the emitted first electromagnetic radiation 11 is preferably adjustable by the first emission means 2.

An evaluation means 5, which is not shown in FIG. 1, is connected in terms of signals at least to the first measuring means 4, the first measuring means 4 transmitting the detected characteristics to the evaluation means 5.

FIG. 2 shows a principle sketch of the device 1 according to an embodiment which corresponds to the device 1 in FIG. 1 but comprises an additional second measuring means 9.

The second measuring means 9 also detects the characteristics of the second electromagnetic radiation 12 emerging from the fluid, the second measuring means 9 being arranged away from the first optical axis X, preferably at an angle in a range of [0°;180°]. The first measuring means 4 and the second measuring means 9 are arranged rotationally symmetrically offset around the first optical axis X, i.e. the first measuring means 4 and the second measuring means 9 are arranged at a different angle to the first optical axis X and are at the same distance from the scattering volume (test volume 3 or fluid). The second measuring means 9 thus also detects a characteristic of the second electromagnetic radiation 12, which arises due to a lateral scattering of the first electromagnetic radiation 11 with the particles in the fluid.

The first measuring means 4 and the second measuring means s 9 each detect the characteristic in an angle-dependent manner, which provides more information for determining the particle sizes.

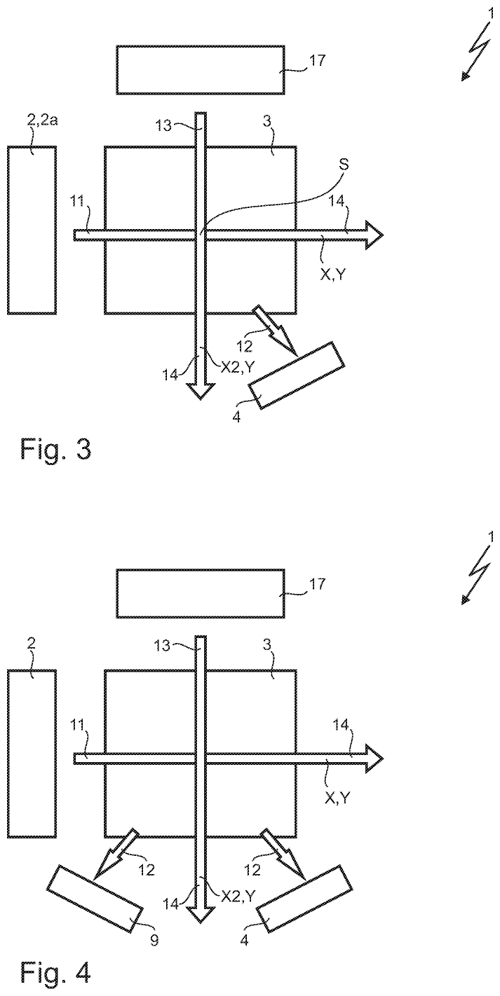

FIG. 3 represents a principle sketch of the device 1 according to one embodiment. The device 1 shown in FIG. 3 corresponds to the device 1 in FIG. 1, with the addition of a second emission means 17.

The second emission means 17 emits a third electromagnetic radiation 13 along a second optical axis X2 into the fluid present in the test volume 3. The emitted third electromagnetic radiation 13 is quasi-monochromatic or a sequence of predetermined wavelengths within a predetermined time interval. Preferably, the wavelength of the emitted third electromagnetic radiation 13 is adjustable by the second emission means 17. The wavelengths of the first electromagnetic radiation 11 and the third electromagnetic radiation 13 may be the same or different.

The first optical axis X and the second optical axis X2 are arranged at an angle of 90° with respect to each other, although other angles in a range of [0°;180° ] are also possible. The first optical axis X and the second optical axis X2 intersect within the test volume 3 in the fluid at the intersection S. The first measuring means 4 is thereby arranged away from the first optical axis X and the second optical axis X2.

FIG. 4 shows a principle sketch of the device 1 according to an embodiment comprising the second emission means 17 and the second measuring means 9.

The first measuring means 4 and the second measuring means 9 are respectively arranged away from the first X and the second optical axis X2. The first measuring means 4 and the second measuring means 9 are each arranged at the same distance from the intersection S, i.e. rotationally symmetrical with respect to the first X and the second optical axis X2.

It is generally conceivable that still further measuring means s 4, 9 are arranged, which are arranged in each case away from the first optical axis X and/or the second optical axis X2 and in each case have the same distance to the scattering volume (test volume 3 or fluid) or to the intersection S.

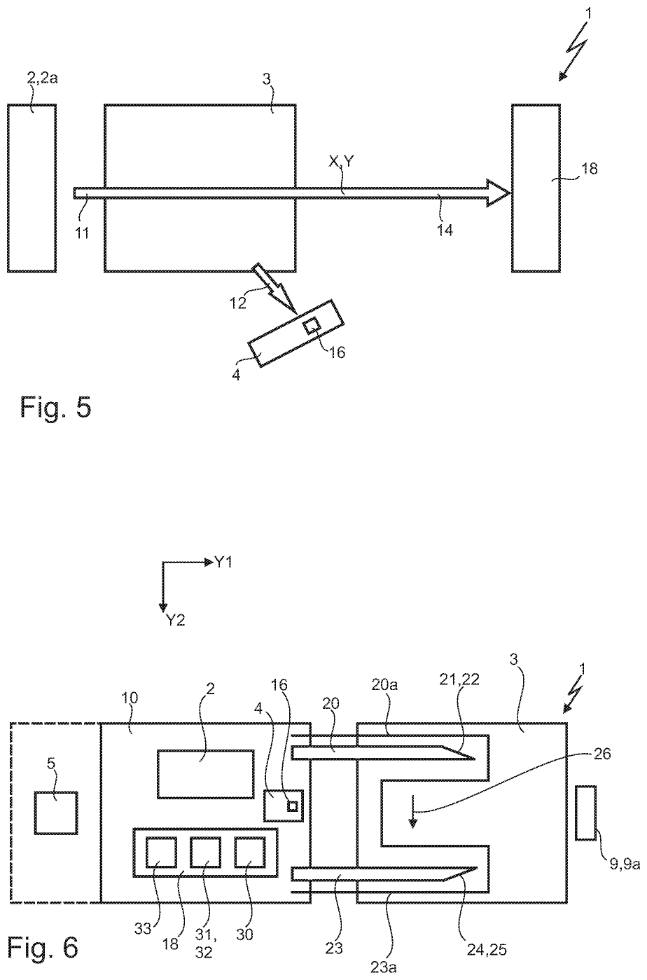

FIG. 5 shows a principle sketch of the device 1 according to one embodiment. The device 1 comprises the emission unit 2, which emits the first electromagnetic radiation 11 along the first optical axis X in the forward direction Y into the test volume 3. Also arranged along the first optical axis X in the forward direction Y behind the test volume 3 is a third measuring means 18. Due to the interaction of the first electromagnetic radiation 11 with particles and groups of substances, the first electromagnetic radiation 11 changes into a fourth electromagnetic radiation 14.

The fourth electromagnetic radiation 14 directed along the first optical axis X in the forward direction Y and conducted out of the test volume 3 is detected by the third measuring means 18, whereby a characteristic of the fourth electromagnetic radiation 14 is detectable. The basic structure of the device 1 shown in FIG. 5 corresponds to the basic structure of an absorption or transmission spectroscopy.

Away from the first optical axis X, the second electromagnetic radiation 12 is detectable by the first measuring means 4, the second electromagnetic radiation 12 being due to lateral scattering of the first electromagnetic radiation 11 with the particles or groups of substances in the fluid.

An evaluation means 5 not shown in FIG. 5 is connected in terms of signals at least to the first measuring means 4 and the third measuring means 18, the first measuring means 4 and/or the third measuring means 18 transmitting the detected characteristics to the evaluation means 5.

FIG. 6 shows a representation of a device 1 according to one embodiment. Here, a component 10 comprises the emission means 2 and the first measuring means 4. Furthermore, the component may comprise the third measuring means 18, which in turn comprises the pinhole 30, the dispersion prism 31 or the diffraction grating 32, and the sensor unit 33. Further, the component may comprise the first light guide 20 and the second light guide 23. Additionally, the component 10 may comprise the evaluation means 5. Preferably, the component 10 comprises a housing 20a in which said components are located. The component 10 has the advantage that this can be easily attached to a test volume 3 as a compact unit. Preferably, the first measuring means 4 is arranged between the first light guide 20 and the second light guide 23.

It is also conceivable that the first measuring means 4 is arranged in a separate transparent housing.

The first light guide 20 and the second light guide 23 are at least partially rod-like along a longitudinal direction Y1 and are arranged parallel to one another. The light guides 20, 23 each have a distal end 21, 24, wherein the surfaces 22, 25 of the distal ends 21, 24 are each beveled at degrees to the longitudinal direction Y1. The first electromagnetic radiation 11 propagating in the first light guide 20 in longitudinal direction Y1 is preferably deflected by 90 degrees by total reflection at the first surface 22 of the first distal end 21 of the first light guide 20. The deflected first electromagnetic radiation 11 subsequently passes perpendicularly through a lateral surface of the first light guide 20 from the latter into the fluid in the test volume 3. Along a test section 26 along the first optical axis X in the test volume 3, the first electromagnetic radiation 11 transitions to the fourth electromagnetic radiation 14. The fourth electromagnetic radiation 14 enters perpendicularly through a cladding surface at the second distal end 24 of the second light guide 23 and is deflected 90 degrees at the second surface 25 by total internal reflection in a direction Y2 opposite to the longitudinal direction Y1, and subsequently exits the test volume 3.

The first light guide 20 is disposed within a transparent housing 20a. Similarly, the second light guide 23 may be arranged within a transparent housing 23a. In this regard, it is advantageous that said transparent housings 20a, 23a are waterproof. The first measuring means 4 and/or the second measuring means 9 can likewise be arranged in a transparent waterproof housing 4a, 9a.

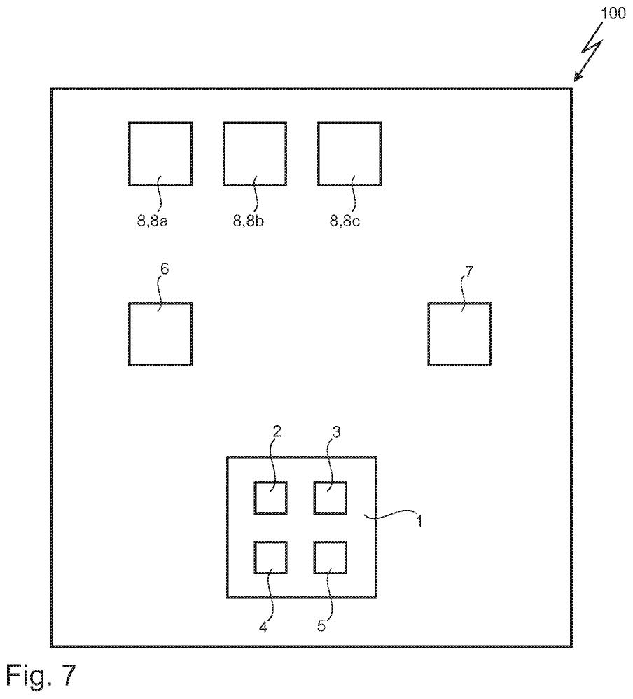

FIG. 7 shows a representation of a household appliance 100 according to one embodiment. The household appliance 100 comprises at least the device 1, which in turn comprises the first emission means 2, the test volume 3, the first measuring means 4, and the evaluation means 5. Further, the household appliance 100 comprises a control means 6 and a storage unit 7. The control means 6 and/or the storage unit 7 may also be part of the device 1. The household appliance 100 further comprises further means 8, for example a feeder means 8a, a feeder means 8b and an adjusting means 8c.

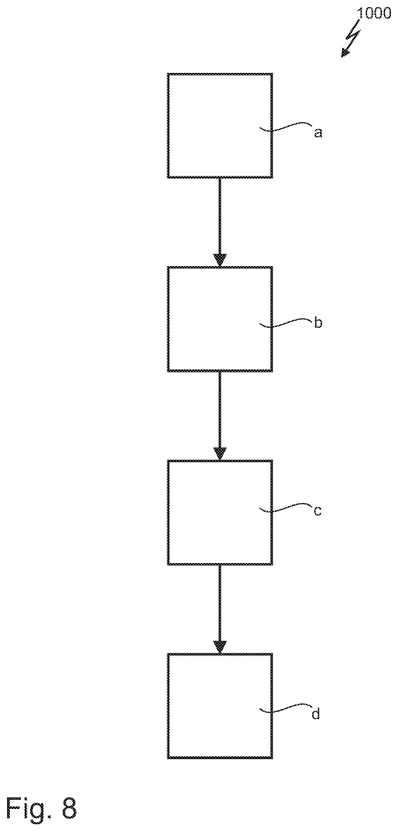

FIG. 8 shows a flow diagram of a procedure 1000 according to one embodiment.

The procedure for particle sizing of particles distributed in a fluid within a household appliance 100, comprises the procedure steps:
a. emitting a first electromagnetic radiation 11 along a first optical axis X into the fluid present in a test volume 3 emitted by means of a first emission means 2;
b. detecting at least one characteristic of a second electromagnetic radiation 12 emitted from the fluid 3 by means of a first measuring means 4;
c. evaluating the characteristic of the second electromagnetic radiation 12 by means of an evaluation means 5; and
d. determining the particle sizes using reference characteristics by means of the evaluation means 5;
wherein the first measuring means 4 is arranged away from the first optical axis X.

Preferably, the emitted first electromagnetic radiation 11 is nearly monochromatic or a sequence of predetermined wavelengths within a predetermined time interval.

The disclosed 1000 procedure may alternatively or cumulatively include any of the features and embodiments described above in the general optional section.

All features disclosed in the application documents are claimed to be essential to the invention insofar as they are individually or in combination new compared to the prior art.

What is claimed is:

1. A device for particle sizing particles distributed in a fluid inside a household appliance, the device comprising:
at least one first emission means emitting a first electromagnetic radiation along a first optical axis into the fluid present in a test volume;
at least one first measuring means which detects at least one characteristic of a second electromagnetic radiation emerging from the fluid; and
an evaluation means which is provided and designed to evaluate characteristics of the second electromagnetic radiation, whereby particle sizes can be detected using reference characteristics;
characterized in that the at least one first measuring means is arranged off the first optical axis.

2. The device according to claim 1, characterized in that the emitted first electromagnetic radiation is nearly monochromatic or is a sequence of predetermined wavelengths within a predetermined time interval.

3. The device according to claim 2, characterized in that a wavelength of the emitted first electromagnetic radiation lies in a range from 360 nm to 10,000 nm, the wavelength of the emitted first electromagnetic radiation being adjustable by the at least one first emission means, the at least one first emission means comprising at least one emission unit with an adjustable wavelength which is selected from a group consisting of a light-emitting diode (LED), in particular a red-green-blue (RGB) or red-green-blue-white (RGBW) LED, and a laser.

4. The device according to claim 1, characterized in that the at least one first measuring means is arranged at an angle in a range of [0°;180°] to the first optical axis.

5. The device according to claim 1, characterized in that the second electromagnetic radiation is a scattered radiation, in particular caused by at least one of Mie scattering and Rayleigh scattering, wherein the at least one first measuring means is configured to detect an intensity of the second electromagnetic radiation, wherein the at least one first measuring means comprises a sensor unit which detects the intensity of the second electromagnetic radiation in an angle-dependent manner, and wherein the sensor unit is selected from a group consisting of a photodiode, a phototransistor, and a bolometer.

6. The device according to claim 1, characterized in that the device comprises a second emission means emitting a third electromagnetic radiation along a second optical axis into the fluid present in the test volume, the emitted third electromagnetic radiation being quasi-monochromatic or being a sequence of predetermined wavelengths within a predetermined time interval, wherein a wavelength of the emitted third electromagnetic radiation is adjustable by the second emission means, and wherein a wavelength of the first electromagnetic radiation and the wavelength of the third electromagnetic radiation are equal or different.

7. The device according to claim 6, characterized in that the first optical axis and the second optical axis are arranged at an angle in a range of [0°;180°], with respect to each other, the first optical axis and the second optical axis intersecting within the test volume in the fluid, and the at least one first measuring means being arranged away from the first optical axis and the second optical axis.

8. The device according to claim 6, characterized in that at least one of the first and the third electromagnetic radiation can be introduced from the respective emission means into the test volume via a first light guide, wherein the first light guide is arranged within a first transparent housing, wherein at least one of the at least one first measuring means and the second measuring means is arranged in a second transparent housing, wherein a fourth electromagnetic radiation is dischargeable from the test volume via a second light guide, and wherein the second light guide is arranged in a third transparent housing.

9. The device according to claim 1, characterized in that the device comprises a second measuring means which detects a characteristic of the second electromagnetic radiation emerging from the fluid, the second measuring means being arranged away from the first optical axis and the second optical axis, and the at least one first measuring means and the second measuring means being arranged rotationally offset about the first optical axis and the second optical axis.

10. The device according to claim 9, characterized in that the device comprises a third measuring means which detects at least one characteristic of a fourth electromagnetic radiation emerging from the fluid, the third measuring means being arranged along the first optical axis or the second optical axis.

11. A household appliance comprising:
the device according to claim 1; and
at least one control means, which is connected in terms of signals to the evaluation means, the at least one control means controlling further means of the household appliance as a function of at least one of determined particle sizes and substance groups.

12. The household appliance according to claim 11, wherein a main component of the fluid is air, characterized in that the at least one control means controls, in dependence on the determined particle sizes, at least one of:
at least one of an air filter device and an air treatment device; and
a communication means capable of transmitting information to a user.

13. The household appliance according to claim 11, in particular a washing machine or a dishwasher, wherein a main component of the fluid is water, characterized in that the at least one control means, as a function of the determined particle sizes, at least one of:
a metering means for a cleaning agent, which can supply at least one of a type, a composition, and an amount of the cleaning agent to the water;
a feeder means which can supply a quantity of water; and
an adjusting means capable of adjusting a cleaning program selected from a plurality of cleaning programs.

14. The household appliance according to claim 13, characterized in that the test volume of the device is located in a machine sump or in a fluidic separable bypass.

15. A method for particle sizing of particles distributed in a fluid within a household appliance, the method comprising:
emitting a first electromagnetic radiation along a first optical axis into the fluid present in a test volume by means of a first emission means;
detecting at least one characteristic of a second electromagnetic radiation emitted from the fluid by means of a first measuring means, characterized in that the first measuring means is arranged away from the first optical axis;
evaluating the at least one characteristic of the second electromagnetic radiation by means of an evaluation means; and
determining particle sizes using reference characteristics by means of the evaluation means.

16. The method according to claim 15, characterized in that the emitted first electromagnetic radiation is nearly monochromatic or is a sequence of predetermined wavelengths within a predetermined time interval.
